(19) United States
(12) Patent Application Publication
(10) Pub. No.: US 2014/0293005 A1
(43) Pub. Date: Oct. 2, 2014

(54) METHOD AND SYSTEM FOR TRANSMITTING/RECEIVING 3-DIMENSIONAL BROADCASTING SERVICE

(71) Applicant: ELECTRONICS AND TELECOMMUNICATIONS RESEARCH INSTITUTE, Daejeon (KR)

(72) Inventors: Gwang Soon LEE, Daejeon (KR); Kug Jin YUN, Daejeon (KR); Hyun Jeong YIM, Seoul (KR); Hyoung Jin KWON, Chungcheongbuk-do (KR); Kwanghee JUNG, Gyeonggi-do (KR); Chan KIM, Daejeon (KR); Namho HUR, Daejeon (KR); Soo In LEE, Daejeon (KR)

(21) Appl. No.: 14/304,032

(22) Filed: Jun. 13, 2014

Related U.S. Application Data
(63) Continuation of application No. 13/100,764, filed on May 4, 2011, now abandoned.

(30) Foreign Application Priority Data
May 7, 2010 (KR) 10-2010-0042832
May 31, 2010 (KR) 10-2010-0051057
Apr. 25, 2011 (KR) 10-2011-0038348

(51) Int. Cl. H04N 13/00

(52) U.S. Cl. CPC H04N 13/0048
USPC 348/43

(57) ABSTRACT

Provided is a method and system of transmitting and receiving a three-dimensional (3D) broadcasting service, and more particularly, to a method and system for transmitting and receiving a reference image and a 3D auxiliary image for the 3D broadcasting service through a digital broadcasting network in real-time or in non-real time. According to the present invention, a smooth broadcasting service may be provided to terminals receiving a two-dimensional (2D) or 3D broadcast.

This application is a continuation application of 13/100,764 filed on May 4, 2011, which claims priority to, and the benefit of, Korean Patent Application No. 10-2010-0042832 filed on May 7, 2010, Korean Patent Application No. 10-2010-0051057 filed on May 31, 2010, and Korean Patent Application No. 10-2011-0038348 filed on Apr. 25, 2011, in the Korean Intellectual Property Office. The content of the aforementioned applications is incorporated herein by reference.

### FIELD OF THE INVENTION

Embodiments below relate to a method and system for transmitting and receiving a three-dimensional (3D) broadcasting service, and more particularly, to a method and system for transmitting and receiving a reference image and a 3D auxiliary image for the 3D broadcasting service through a digital broadcasting network in real-time or in non-real time.

### BACKGROUND ART

A three-dimensional (3D) image may be configured by a reference image and various forms of a 3D auxiliary image (hereinafter, which may be referred to as an auxiliary image), and two images may be respectively converted into left and right images and reproduced through a 3D display, thereby enabling a viewer to sense a cubic effect.

Here, the reference image may correspond to an image compatible with a general two-dimensional (2D) image. The 3D auxiliary image (format) may include half of a vertical (or horizontal) right image, a full right image, a depth image, a disparity image, and the like. For example, when the 3D auxiliary image corresponds to half of the vertical right image, the reference image and the 3D auxiliary image may be converted to images having only odd (even) line image data and even (odd) line image data, and then left and right field images may be simultaneously reproduced by a 3D displayer at the same position within a scene.

Since a 3D image may be configured by a reference image and an auxiliary image, the reference image and the auxiliary image may be required to be transmitted and received to provide a mobile broadcasting service based on an Advanced Television Systems Committee-Mobile/Handheld (ATSC-M/H) standard. However, an existing ATSC standard, that is, a broadcast using a 2D image may exchange only a single image. Accordingly, a more efficient scheme may be used to provide a 3D broadcasting service also compatible with a 2D broadcast.

### DISCLOSURE OF INVENTION

### Technical Goals

An aspect of exemplary embodiments provides a method and system for transmitting and receiving a three-dimensional (3D) broadcasting service capable of transmitting, to terminals, at least one of a reference image, a 3D auxiliary image, and signaling information with respect to the reference image and the 3D auxiliary image by multiplexing the at least one reference image, 3D auxiliary image, and signaling information through a separate channel or by separating the at least one reference image, 3D auxiliary image, and signaling information into different sessions so as to provide a smooth broadcasting service to the terminals receiving a two-dimensional (2D) or 3D broadcast.

Another aspect of the present invention also provides a method and system for transmitting and receiving a 3D broadcasting service in which a transmission system may initially transmit a 3D auxiliary image in a file format to reception terminals and then transmit an audio video (AV) stream of a reference image and signaling information to the reception terminals, and the reception terminals may synchronize the initially transmitted 3D auxiliary image with the AV stream of the reference image so they may be concurrently displayed.

### TECHNICAL SOLUTIONS

According to an aspect of the present invention, there is provided a method of transmitting a three-dimensional (3D) broadcasting service, the method including respectively encoding a reference image and a 3D auxiliary image for the 3D broadcasting service, and respectively generating a reference image stream corresponding to the reference image and a 3D auxiliary image stream corresponding to the 3D auxiliary image, generating signaling information for concurrently broadcasting the generated reference image stream and 3D auxiliary image stream, multiplexing at least one of the generated signaling information, the generated reference image stream, and the generated 3D auxiliary image stream, through channels different from each other, and transmitting the multiplexed result to a reception terminal through a distribution network for a broadcasting service.

The generating of the signaling information may include generating a component corresponding to the reference image stream, generating another component corresponding to the 3D auxiliary image stream, and inserting information about the generated components into the signaling information.

The multiplexing may include multiplexing each of the generated signaling information and the generated reference image stream, through two channels different from each other, and transmitting the 3D auxiliary image to the reception terminal through another distribution network for the broadcasting service.

The method may further include inserting pieces of information indicating a synchronization service section into at least one of the generated reference image stream and the generated 3D auxiliary image stream.

The pieces of information indicating a synchronization service section may be inserted into at least one of the reference image stream and the 3D auxiliary image stream at predetermined intervals.

The pieces of information indicating a synchronization service section may be inserted into at least one of the reference image stream and the 3D auxiliary image stream at predetermined intervals, where information is increased by a predetermined value.

The method may further include transmitting, to the reception terminal, a synchronized event message for controlling a synchronization service between the reference image and the 3D auxiliary image.

According to another aspect of the present invention, there is provided a method of receiving a 3D broadcasting service, the method including downloading in real-time a stream formed by multiplexing at least one of a reference image, a 3D auxiliary image, and signaling information for the 3D broadcasting service through a plurality of channels, decoding the downloaded data, and acquiring the signaling information from the decoded result, analyzing the acquired signaling information, and recognizing a component with respect to at least one of the reference image and the 3D auxiliary image from the analyzed result, and downloading a content item for at least one of the reference image and the 3D auxiliary image based on the recognized component.

When a reception terminal corresponds to a two-dimensional (2D) broadcast reception terminal, the recognizing of a component may include recognizing a component with respect to the reference image from the analyzed result, and the downloading of a content item may include downloading a content item of the reference image, using the component with respect to the reference image.

The method may further include storing a completely downloaded 3D auxiliary image and signaling information corresponding to the 3D auxiliary image, synchronizing the 3D auxiliary image with a reference image that is downloaded in real-time based on the signaling information, and displaying the 3D auxiliary image, wherein the downloading of the multiplexed stream in real-time may include downloading at least one of the 3D auxiliary image and the signaling information through a single distribution network, and completing the download, and downloading in real-time a stream of the reference image associated with the 3D auxiliary image through another distribution network.

According to still another aspect of the present invention, there is provided a transmission system for a 3D broadcasting service, the system including a non-real time (NRT) service encoder to respectively encode a reference image and a 3D auxiliary image for the 3D broadcasting service, and respectively generate a reference image stream corresponding to the reference image and a 3D auxiliary image stream corresponding to the 3D auxiliary image, a signaling information encoder to generate signaling information for concurrently broadcasting the generated reference image stream and the generated 3D auxiliary image stream, a broadcast stream multiplexer to multiplex at least one of the generated signaling information, the generated reference image stream, and the generated 3D auxiliary image stream, through channels different from each other, and a transmitter to transmit the multiplexed result to a reception terminal through a distribution network for a broadcasting service.

According to still another aspect of the present invention, there is provided a reception terminal for a 3D broadcasting service, the terminal including a reception processing unit to download in real-time a stream formed by multiplexing at least one of a reference image, a 3D auxiliary image, and signaling information for the 3D broadcasting service through a plurality of channels, a non-real time (NRT) service decoder to decode the downloaded data, and a signaling information analyzer to acquire the signaling information from the decoded result, analyze the acquired signaling information to recognize a component with respect to at least one of the reference image and the 3D auxiliary image from the analyzed result, and request the reception processing unit for a download of a content item with respect to at least one of the reference image and the 3D auxiliary image based on the recognized component.

When the reception terminal corresponds to a 2D broadcast reception terminal, the signaling information analyzer may recognize a component with respect to the reference image from the analyzed result, and request a download, from the reception processing unit, of a content item of the reference image according to the component with respect to the reference image.

### Effect of Invention

According to an aspect of the present invention, it is possible to provide a three-dimensional (3D) broadcasting service in non-real time or in real-time while guaranteeing a compatibility with a two-dimensional (2D) broadcast of a digital broadcast.

In particular, according to an aspect of the present invention, a high definition image service may be provided through an Advanced Television Systems Committee (ATSC) system as a single radio frequency (RF) signal while 3D content may be serviced through an ATSC non-real time (NRT) service mechanism. A point in time of the service may correspond to a point in time desired by a user or a point in time designated by a service provider.

According to another aspect of the present invention, it is possible to provide a high quality service while minimizing constraints on a transmission bandwidth by initially providing a 3D auxiliary image in a file format to a reception terminal through the Internet, and the like as well as through a broadcasting network, and by providing a reference image through the broadcasting network.

### BRIEF DESCRIPTION OF DRAWINGS

FIG. 1 is a diagram illustrating a configuration of a transmission system employing a method of transmitting and receiving a three-dimensional (3D) broadcasting service according to a first embodiment of the present invention.

FIGS. 2A through 2C are diagrams illustrating a signaling information provided by a non-real time (NRT) broadcasting service in an Advanced Television Systems Committee (ATSC).

FIG. 3 is a diagram illustrating a signaling provided by a method of transmitting and receiving a 3D broadcasting service according to a first embodiment of the present invention.

FIG. 4A and FIG. 4B are diagrams illustrating another example of signaling information provided by a method of transmitting and receiving a 3D broadcasting service according to a second embodiment of the present invention.

FIG. 5A and FIG. 5B are diagrams illustrating another example of signaling information provided by a method of transmitting and receiving a 3D broadcasting service according to a third embodiment of the present invention.

FIG. 6 is a diagram illustrating still another signaling information provided by a method of transmitting and receiving a 3D broadcasting service according to a fourth embodiment of the present invention.

FIG. 7 is a diagram illustrating a configuration of a reception terminal of FIG. 1. FIG. 8 and FIG. 9 are a diagram and a flowchart respectively illustrating an operation of a transmission side in a method of transmitting and receiving a 3D broadcasting service according to a fifth embodiment of the present invention.

FIG. 10A through FIG. 10C are diagrams illustrating information for an initialization operation in a method of transmitting and receiving a 3D broadcasting service according to a fifth embodiment of the present invention.

FIG. 11 is a diagram illustrating an operation of a reception side in a method of transmitting and receiving a 3D broadcasting service according to a fifth embodiment of the present invention.

### BEST MODE FOR CARRYING OUT THE INVENTION

Hereinafter, embodiments of the present invention will be described with reference to attached figures.

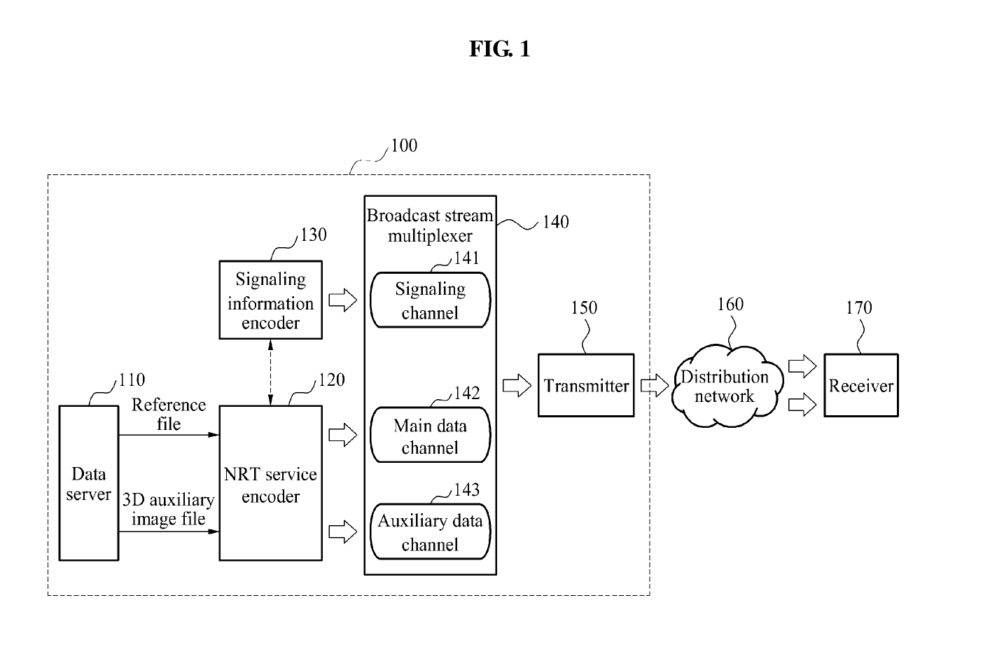

FIG. 1 is a diagram illustrating a configuration of a transmission system 100 employing a method of transmitting and receiving a three-dimensional (3D) broadcasting service according to a first embodiment of the present invention.

Here, content of an object transmitted by the transmission system may correspond to an image, a moving image, text, and the like, and in particular, include a moving image file. The moving image file may be classified into a reference image file and a 3D auxiliary image file, and may be encoded by respective predetermined schemes. The moving image file may be delivered from a data server 110 to a non-real time (NRT) service encoder 120.

The NRT service encoder 120 may encode each of the reference image file and the 3D auxiliary image file of the moving image file in a predetermined data broadcasting standard to provide a non-real time transmission service.

For example, the NRT service encoder 120 for an Advanced Television Systems Committee (ATSC) may encode content files as a transmitted object in a file delivery over unidirectional transport (FLUTE) protocol.

A signaling information encoder 130 may generate a Service Map Table (SMT)-mobile/handheld (MH), a non-real time information table (NRT-IT), and the like to inform terminals of information of a service configuration, information associated with content, and the like.

An encoded result by the NRT service encoder 120 and signaling information generated by the signaling information encoder 130 may be delivered to a broadcast stream multiplexer 140.

In particular, even though the encoded result by the NRT service encoder 120 may correspond to a single stream, the following descriptions will mainly be about generating and delivering packets corresponding to each type of a reference image and a 3D auxiliary image to facilitate reception in a terminal for a general two-dimensional (2D) image.

The broadcast stream multiplexer 140 may multiplex a stream, generated by the signaling information encoder 130 to a separate signaling channel, and two types of data packets encoded by the NRT service encoder 120 to a main data channel and an auxiliary data channel, respectively. The multiplexed result may be delivered to a transmitter 150.

The transmitter 150 may perform operations such as channel encoding, modulation, and the like with respect to the multiplexed result by the broadcast stream multiplexer 140, and transmit the result to a distribution network 160 through a broadcasting channel. A data packet transmitted to the distribution network 160 may be delivered to a reception terminal 170.

Here, in a case of an ATSC NRT service, the data channel may be formed by Internet protocol (IP) packets within a moving picture experts group-transport stream (MPEG-TS), and be classified based on an IP address and a user datagram protocol (UDP) port number. That is, predetermined information about content multiplexed through a predetermined data channel may be inserted into the signaling information generated by the signaling information encoder 130.

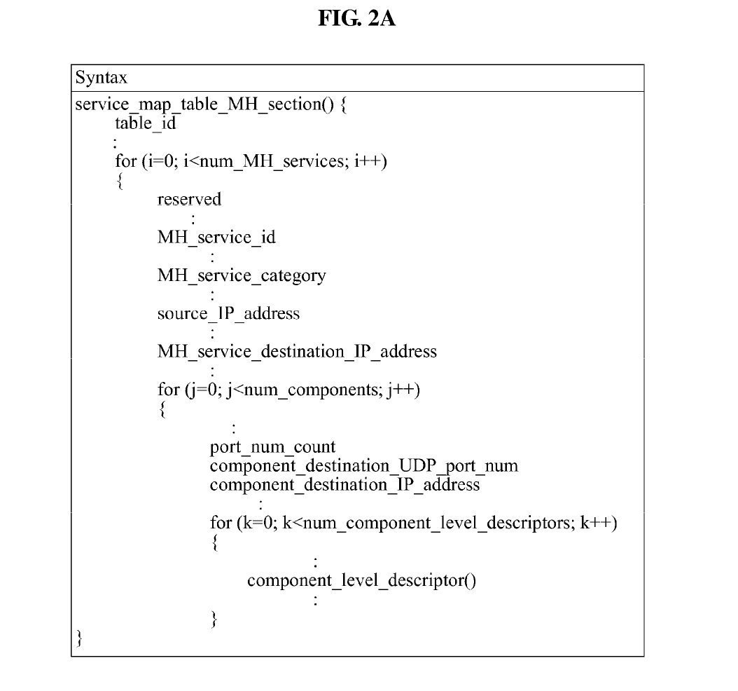

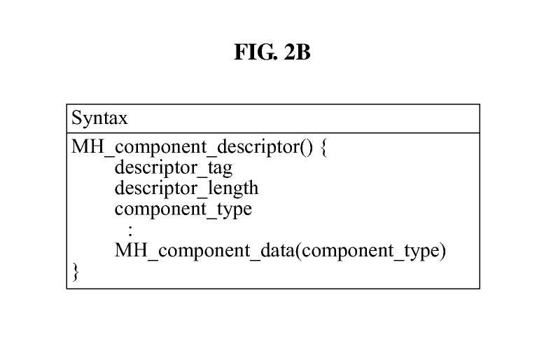

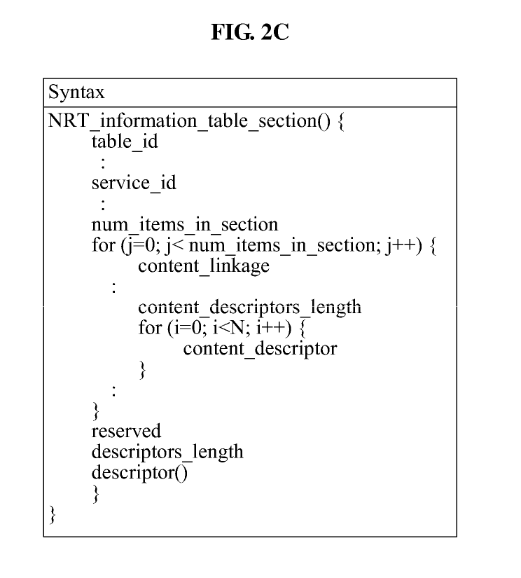

An SMR-MH section may be used in a signaling by an NRT broadcasting service in the ATSC. According to an ATSC-M/H standard, the SMT-MH section may be configured as shown in FIG. 2A.

Referring to FIG. 2A, MH_service_id may correspond to an identifier for classifying a broadcasting service, and a component for configuring a single broadcasting service may be identified by an IP address which includes source_IP_address, MH_service_destination_IP_address, and component_destination_IP_address and component_destination_UDP_port_num.

Here, component_level_descriptor( ) may correspond to a descriptor for describing all components included in a broadcasting service, and describe pieces of information about a component for each component_type. The pieces of information about a component for each component_type may be configured as shown in FIG. 2B.

Referring to FIG. 2B, when the component corresponds to a component encoded in a FLUTE protocol, component_type may be defined to be component_type=38, and the component may include pieces of information about a FLUTE session. The pieces of information may correspond to a Transport Session Identifier (TSI), and the like for classifying the FLUTE session.

To inform a terminal side of a range of information about content during an NRT broadcasting service in the ATSC, the NRT-IT may be transmitted to a signaling channel. Here, the NRT-IT may include pieces of information such as a title of a content item, a valid time for downloading, a content identifier such as content_linkage, and the like enabling a terminal to download several content items.

In the NRT-IT, each content item may be configured as at least one file, and be downloaded in a terminal through an IP stream, basically using the FLUTE protocol.

The NRT-IT may be configured as shown in FIG. 2C.

Referring to FIG. 2C, Table_id may correspond to an ID for identifying an NRT_IT table section, and Service_id may correspond to information capable of linking an associated SMT-MH through a correlation with MH_Service_id. Here, content_linkage may correspond to an ID for classifying a content item provided through an NRT service, and may link information defined in an NRT_IT table with files transmitted through a FLUTE, in the ATSC. When content_linkage in a File Description Table (FDT) and content_linkage in the NRT-IT have the same value in the FLUTE corresponding to a file transmission protocol, contents described in the NRT_IT may be associated with files transmitted through the FLUTE protocol. In this instance, content_descriptor may define descriptors of a content level for describing information with respect to each content.

When all content items associated with a reference image and a 3D auxiliary image are provided in non-real time through an NRT content transmission mechanism, it may be advantageous to a terminal receiving an existing 2D broadcasting service (hereinafter, which may be referred to as a 2D broadcast reception terminal) to download only content associated with the reference image so as to reduce a terminal memory capacity, content download time, and the like, and a corresponding mechanism may be used.

In other words, when a terminal used as an object being provided with a broadcasting service corresponds to the 2D broadcast reception terminal, the 2D broadcast reception terminal may recognize information about the reference image based on signaling information provided from a transmission system and selectively download a content item associated with the reference image.

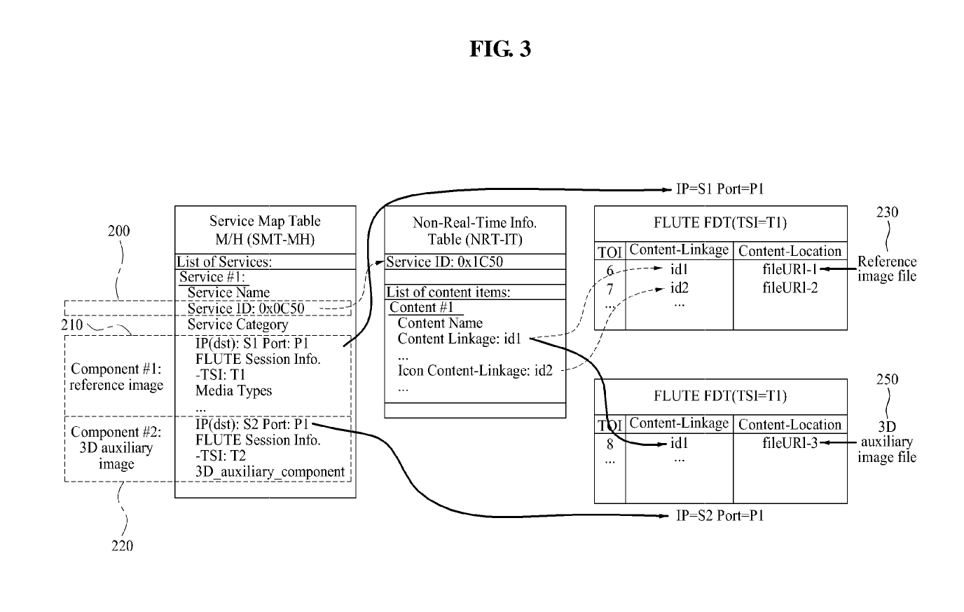

FIG. 3 is a diagram illustrating a signaling provided by a method of transmitting and receiving a 3D broadcasting service according to a first embodiment of the present invention.

Referring to FIG. 3, configuration information of a service and components may be described in an SMT-MH section for a different signaling.

To enable a 2D broadcast reception terminal to select and receive a reference image file easily, a transmission system may configure separate components, such as signaling information, with respect to each of a reference image and a 3D auxiliary image.

The separate components may form channels different from each other using an IP address and a port number (corresponding to component_destination_IP_address and component_destination_UDP_port_num). The separate components may describe different FLUTE session information, for example, the reference image: TSI=T1 and 3D auxiliary image: TSI=T2, through component_level_descriptor( ).

In particular, component #2 220 corresponding to a component for configuring the 3D auxiliary image may define that component_type is the 3D auxiliary image, that is, component_type=3D_auxiliary_component, for example, 43 through component_level_descriptor( ). That is, component #2 220 for configuring the 3D auxiliary image may describe a range of information about the 3D auxiliary image, for example, an encoding format, a left and right division, a corresponding reference image indicator, a 3D auxiliary image format, and the like.

Accordingly, the 2D broadcast reception terminal may not recognize 3D_auxiliary_component while recognizing component_type corresponding to the reference image, for example, Media types and thus, may easily select component#1 210 corresponding to the reference image to request a downloading. Conversely, a 3D broadcast reception terminal may recognize both of component_type corresponding to the reference image and 3D_auxiliary_component corresponding to the 3D auxiliary image and thus, may be provided with content corresponding to the reference image and the 3D auxiliary image.

Further, a transmission terminal may add separate attribute values to a FLUTE FDT (TS1=T1) of a session where the 3D auxiliary image is transmitted, which may correspond to another embodiment for a scheme of inhibiting the 2D broadcast reception terminal from recognizing the 3D auxiliary image.

As illustrated in FIG. 3, multiple FLUTE FDTs may be provided, and information about the reference image and information about the 3D auxiliary image may be inserted to different FLUTE FDTs. Accordingly, the 2D broadcast reception terminal may recognize a FLUTE FDT in which the information about the reference image is inserted, and not recognize a FLUTE FDT in which information about the 3D auxiliary image is inserted.

An NRT-IT may correspond to a table for describing information about a content item, and be associated with the SMT-MH. Here, content #1 of the NRT-IT corresponding to a single content item identified by contents Linkage (id1) according to the first embodiment of the present invention may be configured as two types of files for the reference image and the 3D auxiliary image.

Each of the reference image and the 3D auxiliary image may be transmitted through a different FLUTE session, for example, TSI=T1 for the reference image and TSI=T2 for the auxiliary image. Each FLUTE session may describe information related to files included in a file delivery table (FDT).

According to the first embodiment of the present invention, the reference image and the 3D auxiliary image may be transmitted through different FLUTE sessions and thus, different FDTs may be used for each FLUTE session. The different FDTs may respectively describe information about two types of files, that is, the reference image and the 3D auxiliary image. For example, a first FDT may correspond to an FDT for the reference image, and have Transport Object Identifier (TOI)=6, Content-Linkage=id1, and contents-location=fileURI-1, and a second FDT may correspond to an FDT for the 3D auxiliary image, and have TOI=8, Content-Linkage=id1, and contents-location=fileURI-3. Here, Content-Linkage=id2 may correspond to a content item for an icon to be viewed in a terminal.

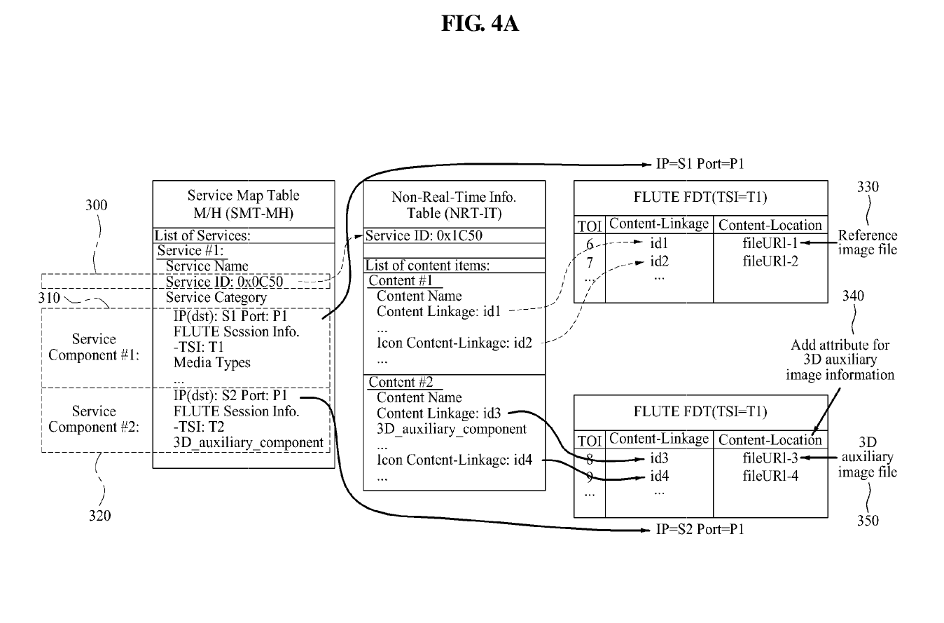

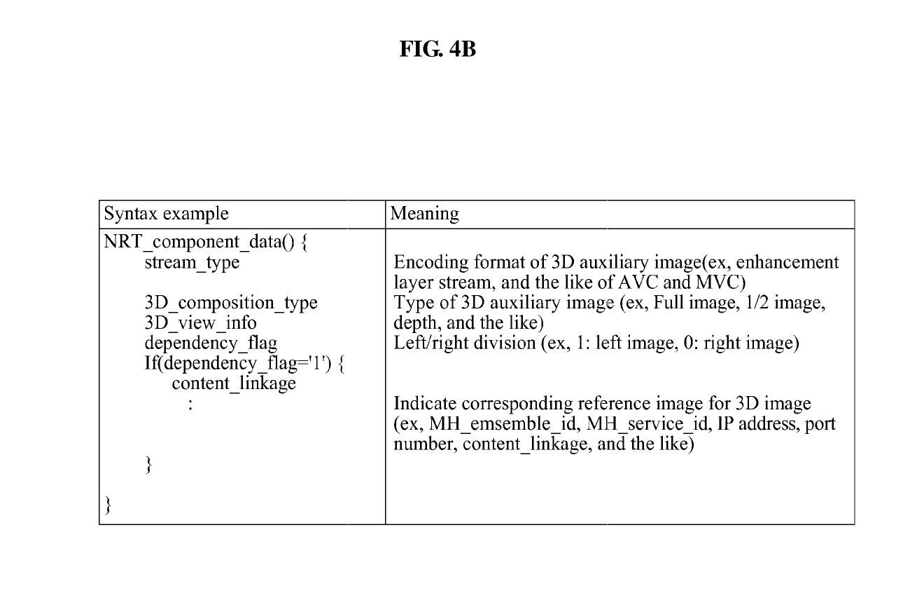

FIG. 4A is a diagram illustrating another example of signaling information provided by a method of transmitting and receiving a 3D broadcasting service according to a second embodiment of the present invention.

A second embodiment is different from the first embodiment, in that, content items for a reference image and a 3D auxiliary image may be respectively designated with respect to a single service ID 300.

A terminal for receiving the 3D broadcasting service (hereinafter, which may be referred to as a 3D broadcast reception terminal) may display a virtual representation rather than displaying each of two content items, that is, Content-Linkage=id1 and Content-Linkage=id3 to a user.

Thus, an NRT-IT may be coded as illustrated in FIG. 4B with respect to the second embodiment.

Referring to FIG. 4B, the NRT-IT may describe signaling information about content in Content #2 corresponding to a content item for a 3D auxiliary image through component_level_descriptor( ).

In particular, component_type is defined to be the 3D auxiliary image in the second embodiment, that is, component_type=3D_auxiliary_component, for example, 43, and a range of information about the 3D auxiliary image, for example, an encoding format, a left and right division, a corresponding reference image indicator, a 3D auxiliary image format, and the like may be described.

Accordingly, a transmission system in the second embodiment may use an FDT for transmitting the reference image and an FDT for transmitting the 3D image, and provide, to reception terminals, content items of the reference image and the 3D image through each FDT.

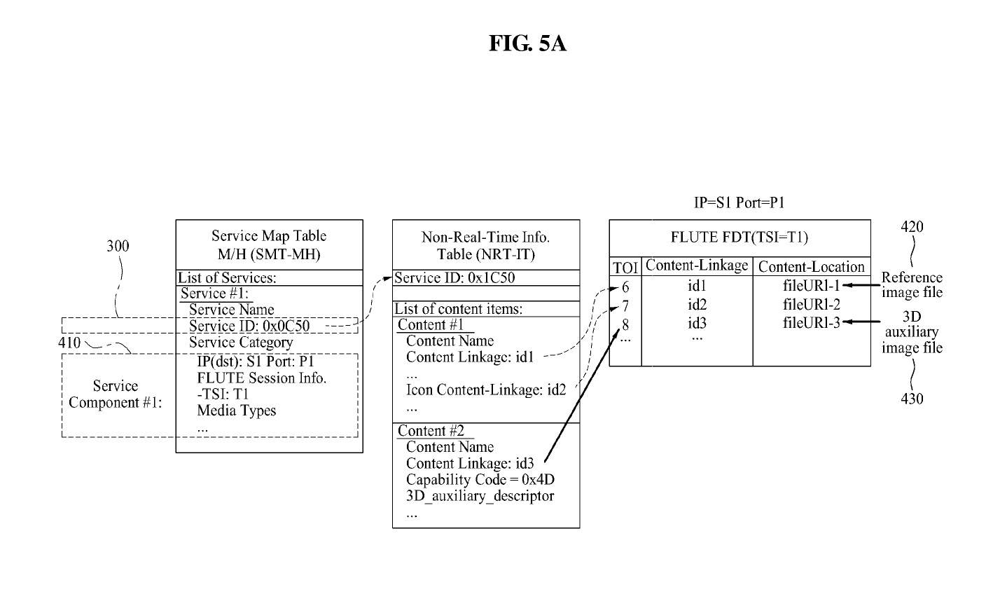

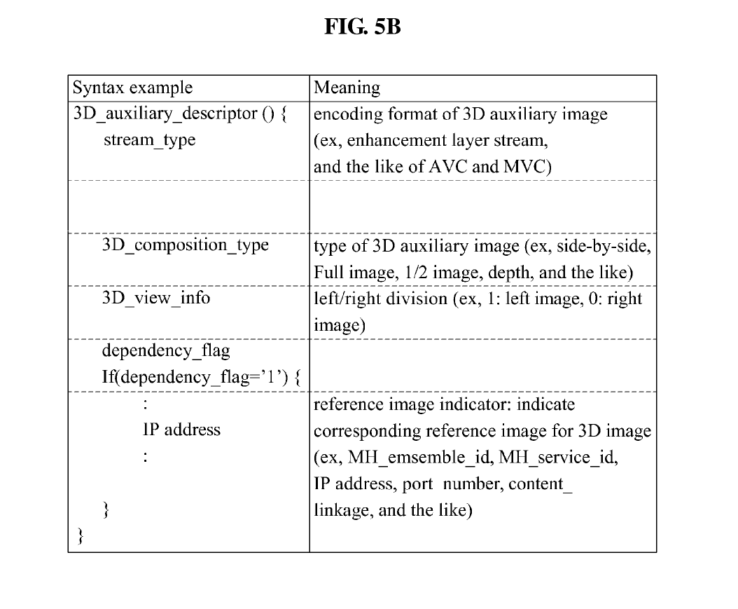

FIG. 5A is a diagram illustrating another example of signaling information provided by a method of transmitting and receiving a 3D broadcasting service according to a third embodiment of the present invention.

In the third embodiment, a reference image and a 3D auxiliary image may be transmitted to a single component 410 with respect to a single service ID 400, and Content #1 corresponding to a content item for the reference image and Content #2 corresponding to a content item for the 3D auxiliary image may be separately designated in an NRT-IT. A single FLUTE session may exist and thus, a single FDT may be used.

Additionally, capabilities descriptor and 3D_auxiliary_descriptor may be added to content #2, which is a content item corresponding to the 3D auxiliary image. Here, the capabilities descriptor may be previously established in an ATSC NRT standard, and report objects associated with a performance of an NRT service and content items, that is, a download protocol, a Forward Error Correction (FEC), a compression algorithm, a media type, and the like.

In the third embodiment, Capability Codes defined in the capabilities descriptor of a content item corresponding to the 3D auxiliary image may be designated as a code value dedicated for the 3D auxiliary image, for example, 0×4D, thereby determining the content item may not be decoded in an analysis process by a 2D receiver.

The transmission system may add 3D_auxiliary_descriptor to a content item, that is, content #2 to describe a range of information with respect to the 3D auxiliary image, for example, an encoding format, a left and right division, a corresponding reference image indicator, a 3D auxiliary image format, and the like. For example, the aforementioned 3D_auxiliary_descriptor may be described as illustrated in FIG. 5B.

Here, the corresponding reference image indicator may be used for indicating contents #1, and a contents_linkage value may be used for the corresponding reference image indicator.

Rather than displaying two content items concurrently, that is, Content-Linkage=id1 and Content-Linkage=id3 to the user, a 3D broadcast reception terminal may previously display a content item #1, that is, Content-Linkage=id1, and then download a content item #2, that is, Content-Linkage=id3 in response to a selection of Content-Linkage=id1 by a user and display Content-Linkage=id1 and Content-Linkage=id3 concurrently.

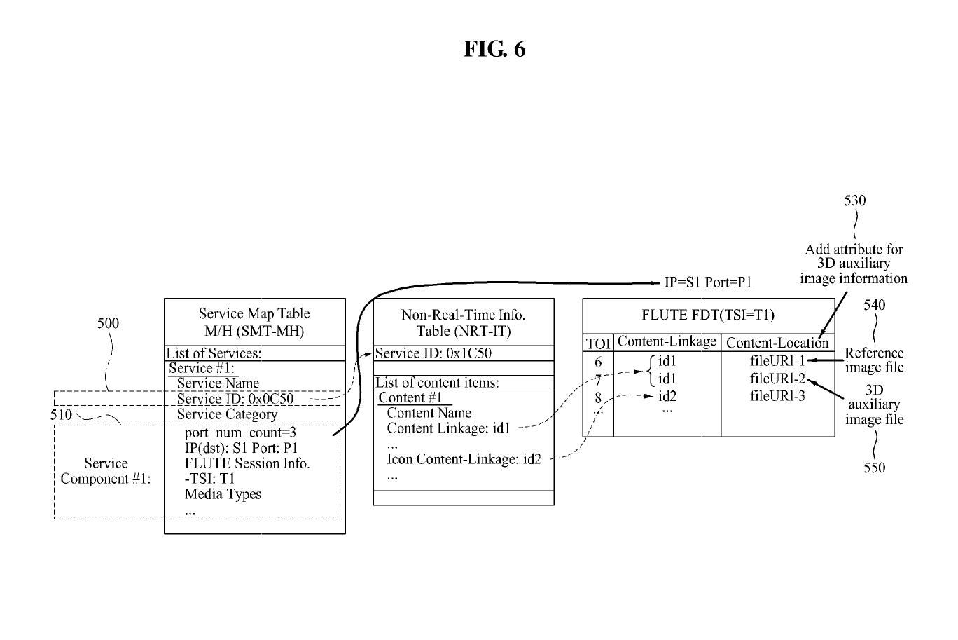

FIG. 6 is a diagram illustrating another example of signaling information provided by a method of transmitting and receiving a 3D broadcasting service according to a fourth embodiment of the present invention.

In the fourth embodiment, a component and a FLUTE session may not be classified to transmit a content item with respect to a 3D auxiliary image other than a reference image. That is, a transmission system may transmit a content item associated with the reference image and the 3D auxiliary image through a single component and a single FLUTE session.

Here, a single FLUTE session may exist and thus, a single FDT may be used. The transmission system may insert information about the reference image and the 3D auxiliary image file into the single FDT.

In particular, an existing FDT may include attributes such as a TOI, a contents-linkage, a contents-location, and the like for each element to described information about a file. Here, in the third embodiment of the present invention, attributes for information about the 3D auxiliary image file may be added to describe the 3D auxiliary image file.

The added attributes may include a range of information about the 3D auxiliary image described through the aforementioned component_level_descriptor( ) for example, 3D_auxiliary_component, an encoding format, a left and right division, a corresponding reference image indicator, a 3D auxiliary image format, and the like.

The single FDT may be transmitted to a separate UDP port, for example, port=P1 for a prompt download in a reception terminal. The third embodiment may include a transmission to the separate UDP so that the reference image and the 3D auxiliary image may be easily downloaded in the reception terminal.

For a transmission to a separate UDP, port_num_count may be set to a value greater than or equal to 3, for example, a port for an FDT+a port for a reference image+a port for a 3D auxiliary image. The port_num_count may correspond to a number of port numbers in the same UDP destination IP, and be used to classify channels.

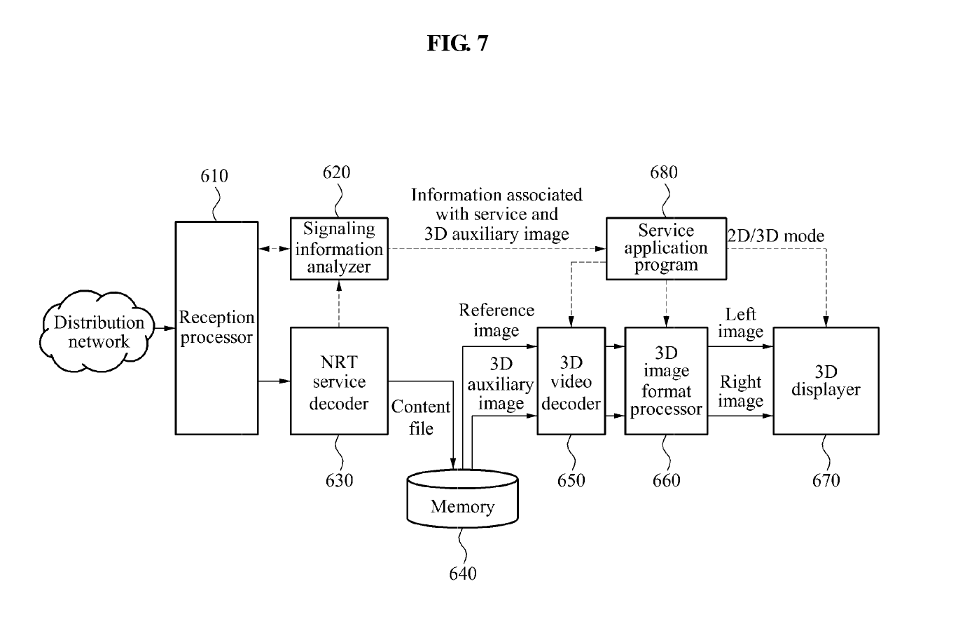

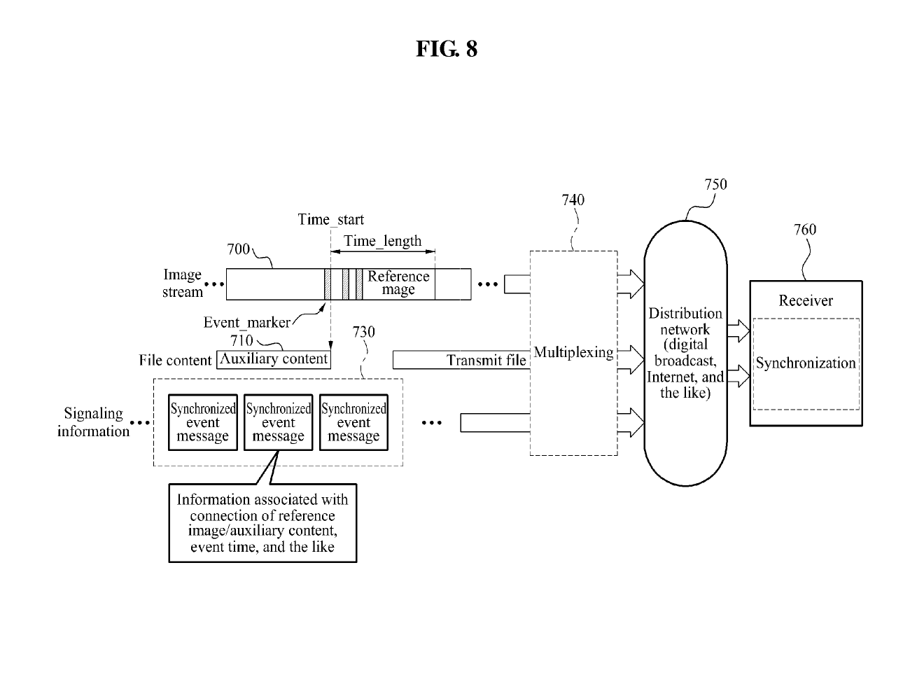

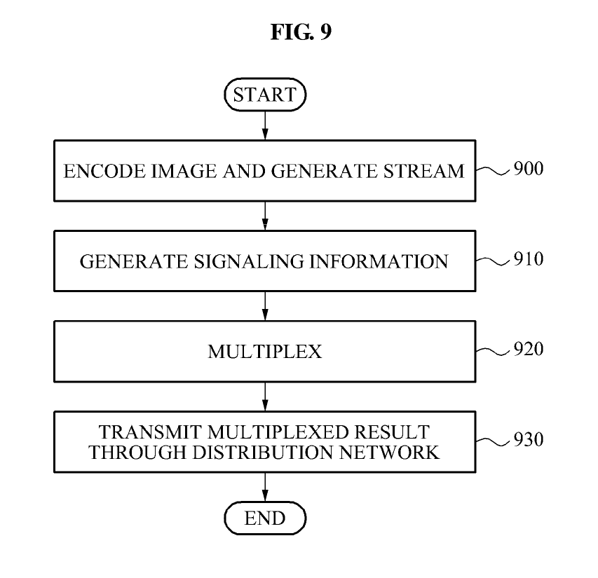

FIG. 7 is a diagram illustrating a configuration of a reception terminal 600 of FIG. 1. Referring to FIG. 7, the reception terminal 600 may include a reception processor 610, a signaling information analyzer 620, an NRT service decoder 630, a memory 640, a 3D video decoder 650, a 3D image format processor 660, a 3D displayer 670, and a service application program 680.

The reception processor 610 may perform a function such as a reception of an RF signal, a demodulation, a channel decoding, and the like. In particular, the reception processor 610 may receive a stream multiplexed by a transmission system and transmitted from a distribution network, and extract, from the received stream, signaling information including service information selected by a user. The extracted signaling information may be delivered to each of the signaling information analyzer 620 and the NRT service decoder 630.

Here, since a signaling channel with respect to the signaling information is initially designated, the signaling information analyzer 620 may analyze a signaling table value such as an SMT-MH, an NRT-IT, and the like transmitted through the signaling channel, and output the analyzed result.

Through the analysis, the signaling information analyzer 620 may recognize channels through which the reference image and the 3D auxiliary image are transmitted, and respectively acquire a stream corresponding to the reference image and a stream corresponding to the 3D auxiliary image for each recognized channel.

The NRT service decoder 630 may receive information used for a content download from the signaling information analyzer 620, and download content files used for an NRT service in a valid time interval based on a content file transmission protocol, for example, a FLUTE protocol. Basically, the NRT service decoder 630 may initially download at least one FDT, analyze the downloaded FDT, locate each content, and subsequently download content files corresponding to the located position.

The memory 640 may store the downloaded content files, and then provide the stored content files in response to a call of a service application program or a call occurring at a predetermined time. Then, the stored content files may be delivered to the 3D video decoder 650 to be decoded.

The service application program 680 may determine whether a current broadcasting service corresponds to a 3D broadcasting service or a 2D broadcasting service based on the analysis result from the signaling information analyzer 620, and deliver the determination result to the 3D video decoder 650, the 3D image format processor 660, and the 3D displayer 670.

When the current broadcasting service corresponds to the 2D broadcasting service, the 3D video decoder 650 may call and decode only a reference image provided by the memory 640. In contrast, when a broadcasting service of the reception terminal 600 corresponds to the 3D broadcasting service, the 3D video decoder 650 may call a reference image and a 3D auxiliary image file concurrently, and synchronize and decode the called files through a synchronization mechanism.

When a reference image is completely downloaded, earlier than a 3D auxiliary image, during a download operation, the reception terminal 600 may initially display only a 2D image configured using the reference image, and additionally display a 3D auxiliary image downloaded thereafter. In this instance, the reception terminal 600 may use a mechanism capable of synchronizing a file from an intermediate time point rather than a starting time point.

The 3D image format processor 660 may receive at least one of a reference image and a 3D auxiliary image decoded by the 3D video decoder 650, and may generate left and right images according to a 3D rendering algorithm determined based on signaling information such as a format of a 3D auxiliary image.

The service application program 680 may control the NRT service decoder 630, the 3D video decoder 650, the memory 640, the 3D image format processor 660, and the like.

In particular, the 3D displayer 670 may operate in a 2D or 3D display mode and display an image according to a control of the service application program 680.

Accordingly, through the distribution network, a stream with respect to the reference image and a stream with respect to the 3D auxiliary image may be streamed through different channels and thus, the reference image may be displayed when the reception terminal corresponds to a 2D broadcast reception terminal and the reference image and the 3D auxiliary image may be synchronized and displayed concurrently when the reception terminal corresponds to a 3D broadcast reception terminal. Thus, a digital broadcast may provide a 3D broadcast while guaranteeing compatibility with a general 2D broadcast.

Further, the digital broadcast may provide a high definition image service as a single RF signal in real-time through an ATSC system, and provide a 3D content in non-real time through an ATSC NRT service mechanism at a point in time desired by a user or a point in time designated by a service provider.

In this instance, a mechanism for synchronizing an audio video (AV) stream transmitted in real-time, for example, the reference image and a stream transmitted in non-real time, for example, the 3D auxiliary image may be implemented as follows.

The aforementioned mechanism may be used for previously transmitting the 3D auxiliary image in a file format to the reception terminal through a broadcast network or a communication network, and then synchronizing the 3D auxiliary image with a real-time stream that is streamed thereafter. An implementation of the synchronization may include a rough synchronization and a precise synchronization in an image frame unit.

FIG. 8 and FIG. 9 are a diagram and a flowchart respectively illustrating an operation of a transmission side in a method of transmitting and receiving a 3D broadcasting service according to a fifth embodiment of the present invention.

Referring to FIG. 8, in operation 740, an AV stream 700 of a reference image, a 3D auxiliary content 710, and signaling information 730 may be multiplexed through each channel. That is, data of the multiplexed result may be transmitted to a reception terminal 760 through a distribution network 750.

Here, the signaling information 730 may correspond to at least one of a synchronization service section, information about a connection of a real-time stream and file content, and time information. The signaling information 730 may be transmitted to the reception terminal 600 along with data corresponding to a reference image or data corresponding to a 3D auxiliary image, as necessary.

Referring to FIG. 9, in operation 900, a reference image and a 3D auxiliary image for the 3D broadcasting service are respectively encoded, and a reference image stream corresponding to the reference image and a 3D auxiliary image stream corresponding to the 3D auxiliary image are respectively generated.

In operation 910, signaling information for concurrently broadcasting the generated reference image stream and 3D auxiliary image stream is generated.

Here, in operation 910, a component corresponding to the reference image stream may be generated, another component corresponding to the 3D auxiliary image stream may be generated, and information of the generated components may be inserted into the signaling information.

In operation 920, at least one of the generated signaling information, the generated reference image stream, and the generated 3D auxiliary image stream is multiplexed, through channels different from each other.

In operation 930, the multiplexed result is transmitted to a reception terminal through a distribution network for a broadcasting service.

Thus, a 3D broadcast reception terminal may extract and display each of the reference image and the 3D auxiliary image from transmitted data that is formed by multiplexing the reference image and the 3D auxiliary image through separate channels, according to the signaling information. A 2D broadcast reception terminal may separately download and display the reference image between the reference image and the 3D auxiliary image multiplexed through separate channels.

Accordingly, both of the 2D broadcast reception terminal and the 3D broadcast reception terminal may receive a broadcasting service in the method of transmitting and receiving a 3D broadcasting service.

Operation 920 may correspond to another embodiment. In operation 920, the generated signaling information and the generated reference image stream may be multiplexed through two channels different from each other, and the 3D auxiliary image may be transmitted to the reception terminal through another distribution network for the broadcasting service. A transmission system may initially provide the 3D auxiliary image in a file format to the reception terminal, and stream the reference image in real-time.

The signaling information may be provided to the reception terminal along with a reference image stream or the 3D auxiliary image.

The transmission system may provide information indicating a synchronization service section so that the reception terminal may synchronize a previously provided 3D auxiliary image with the reference image streamed in real-time. The information indicating a synchronization service section may be inserted into at least one of the generated reference image stream and the generated 3D auxiliary image stream, at predetermined intervals or at predetermined intervals where information is increased by a predetermined value.

Further, the transmission system may transmit, to the reception terminal, a synchronized event message for controlling a synchronization service between the reference image and the 3D auxiliary image.

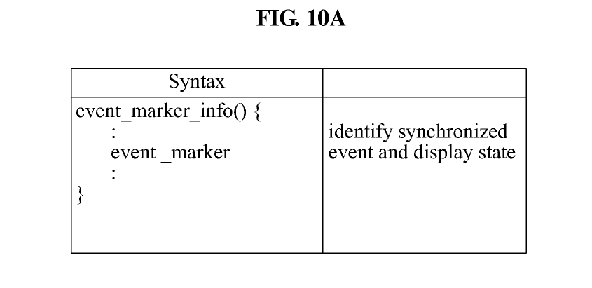

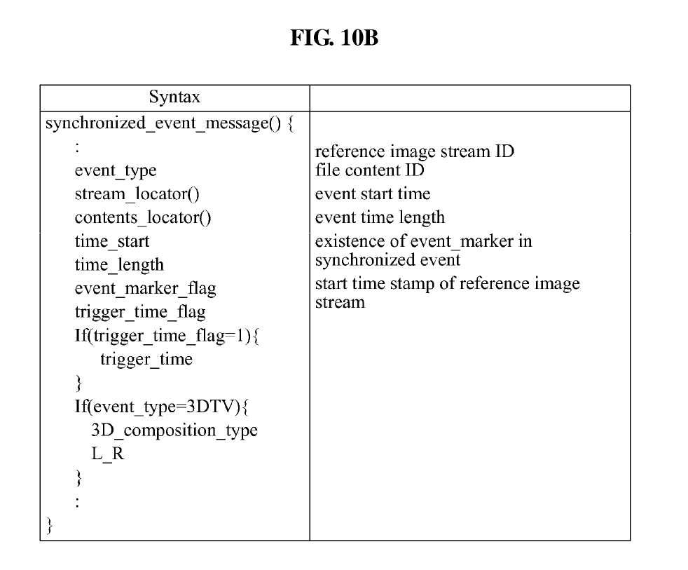

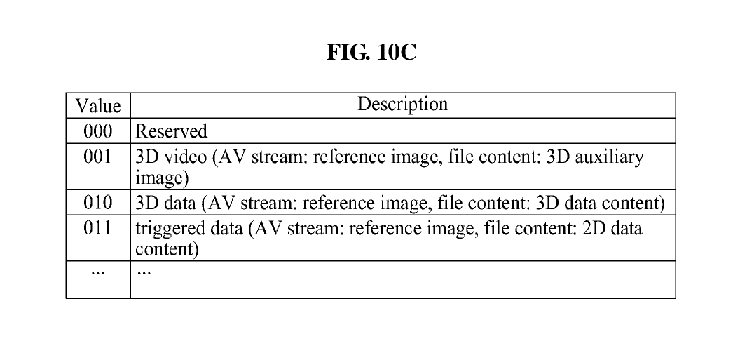

An AV stream of the reference image may correspond to a bitstream compressed for a real-time broadcast, and formed by multiplexing a video, an audio, and various data. Thus, event_mark may be inserted to indicate the synchronization service section in the AV stream in the synchronization scheme. As an example, the event_mark may have a form of a predetermined message or a descriptor as illustrated in FIG. 10A.

Referring to FIG. 10A, the event_mark may be inserted into a table for program information of the AV stream, for example, a program map table (PMT), an SMT of an ATSC, and the like, or inserted into a header of a predetermined packet configuring the AV stream, for example, MPEG-2 TS, PES, IP, and the like.

In particular, the event_marker may have a changed state (or value) from a first access unit (AU) of a reference image stream for synchronization, and be inserted into the AV stream at predetermined intervals. In this instance, the synchronization scheme may be particularly useful for synchronization for each image frame in a synchronization mechanism using time stamp information, for example, a Presentation Time Stamp (PTS) and a Composition Time Stamp (CTS) of the MPEG, and a time stamp of a real-time transport protocol (RTP).

A value of the event_marker may be increased to a predetermined value and then inserted. In this instance, even though a first event_marker is missing in the reception terminal or a user requests a service after a first AU of a reference image stream, the reception terminal may be capable of synchronizing a time point other than an initial portion of an image frame.

A file content may correspond to a multimedia content such as, for example, a moving image, audio, data, a still image, a hyper text markup language (HTML), an eXtensible MarkUp Language (XML), and the like, and be downloaded in the reception terminal before time_start corresponding to a starting time of a synchronized event. The signaling information may be configured in a separate table, for example, an SMT, NRT_IT, and the like of an ATSC NRT including a channel where a file content is downloaded, a download time, and various attributes with respect to the file content.

In the fifth embodiment, a synchronized event message may be additionally provided to control a synchronization service between the reference image and the file content.

The synchronized event message may be repeatedly transmitted to the reception terminal before time_start corresponding to a starting time for a synchronized event. Thereafter, the reception terminal may call previously downloaded file contents from a memory based on the synchronized event message, and hold the file contents at the time_start.

The synchronized event message may be defined as a separate table or a descriptor to be inserted into an existing table, for example, the NRT_IT of the ATSC NRT.

In the synchronization scheme, a real-time AV stream, a file content, and signaling information may be multiplexed in a single stream, and the multiplexed result may be distributed to a terminal through a single network. In another embodiment, the real-time AV stream, the file content, and the signaling information may exist as a plurality of streams, and each of the plurality of streams may be distributed to a terminal through networks different from each other.

In an embodiment as follows, an AV stream may be broadcasted through a digital broadcasting network, and file content and signaling information may be previously downloaded through an IPTV, the Internet, and the like. In this instance, an available synchronized event message may be implemented as illustrated in FIG. 10B, as an example.

Referring to FIG. 10B, event_type denotes a service type provided by a real-time or non-real time synchronization. For example, the event_type may include a 3D video, 3D data, triggered data, and the like as illustrated in FIG. 10C.

A 3D auxiliary image may correspond to an image used for a 3D image, for example, a right side image, a depth image, a disparity image, and the like, and data content may indicate content for a data service such as a still image, an HTML, an XML, and the like. Various synchronized events may be further defined.

Stream_locator( ) may correspond to an indicator for indicating a stream associated with a reference image in an AV stream. The Stream_locator( ) may correspond to transport_stream_id, elementary_PID, and the like in a case of an MPEG-2 system, and correspond to IP address, port number, and the like in a case of an IP protocol.

Contents_locator( ) may correspond to an ID for indicating a previously downloaded file content. The Contents_locator( ) may include a content name, a uniform resource identifier (URI), contents_linkage of an ATSC NRT, a uniform resource locator (URL), and the like.

In this instance, time_start denotes a starting time of a synchronized event. Here, time_start may be set to an absolute time value of a format such as Universal Time Coordinated (UTC), thereby enabling the reception terminal to initially recognize a real-time or non-real time synchronization service event. The reception terminal may use the time_start to perform a function such as a service provision reservation, a loading of file content from a memory, and the like.

Further, time_length may be set to a second unit and denote a temporal length of a synchronized event. Thus, the reception terminal may provide a rough synchronization service, using information about the time_start and time_length. In the aforementioned synchronization scheme, a value of event_marker_flag may be provided to perform a precise synchronization service.

A rough synchronization may reproduce a previously downloaded file content from a time_length value, thereby roughly synchronizing with a reproduction time point of a real-time reference image, even though the synchronization may not be in a frame unit. When a reproduction time of a predetermined advertisement provided in a real-time reference image is initially reported, the time interval may be set to time_start and timelength, thereby enabling the predetermined advertisement in real-time and file content associated with the predetermined advertisement in non-real time to be reproduced concurrently.

The reception terminal may verify whether a value of event_marker_flag in the synchronized event message corresponds to a predetermined value such as 1, and recognize that event_marker is inserted in an AV stream. The reception terminal may perform a relatively more precise synchronization mechanism by referring to the value of event_marker in the AV stream based on the value of the event_marker_flag.

The reception terminal may check a value of event_marker in the AV stream. When the value of event_marker corresponds to a predetermined initial value, the reception terminal may be aware of a start of a synchronized event. When the value of event_marker exceeds the predetermined initial value, the reception terminal may be aware that a synchronized event with respect to the AV stream is in progress.

The reception terminal may estimate a time stamp of an AV stream with respect to a current time point based on an event_marker value greater than the initial value, and reproduce file content from a time interval corresponding to the estimated time stamp. The reception terminal may concurrently reproduce the AV stream and an image file of the time interval corresponding to the estimated time stamp, thereby performing a synchronization in a frame unit.

Depending on circumstances at the time, event_marker may be inserted at constant time intervals into file content previously transmitted in non-real time as well as into an AV stream.

The reception terminal may use only a value of trigger_time_flag other than event_marker. When the trigger_time_flag corresponds to “1,” the reception terminal may estimate a value of a time stamp of a first AU of a reference image stream in an AV stream, for example, a time stamp of a PTS, a CTS, and an RTP of an MPEG, and insert the estimated value into the synchronized event message. Here, the value of a time stamp of a first AU of a reference image stream may indicate a start of a synchronized event, and be difficult to be estimated initially. Thus, the reception terminal may suspend inserting a value with respect to the time stamp while periodically transmitting the synchronized event message, and insert a value estimated with respect to the time stamp into the synchronized event message from a time point when the estimation is possible.

A transmission system may provide information about additional information used for the reception terminal by applying a value to event_type.

For example, a transmitter may set the event_type to a value corresponding to a 3D video, and add format information of the 3D video such as 3D_composition_type, left and right division information, and the like to the AV stream.

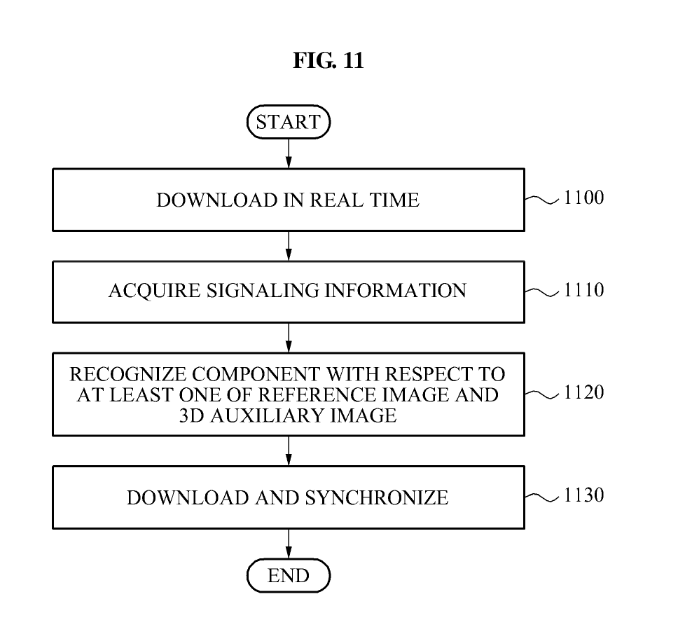

FIG. 11 is a diagram illustrating an operation of a reception side in a method of transmitting and receiving a 3D broadcasting service according to a fifth embodiment of the present invention. A description below includes transmitting signaling information to a reception terminal concurrently with 3D auxiliary image data.

In operation 1100, the reception terminal downloads in real-time a stream formed by multiplexing at least one of a reference image, a 3D auxiliary image, and signaling information for the 3D broadcasting service through a plurality of channels.

In operation 1110, the reception terminal decodes the downloaded data, and acquires the signaling information from the decoded result.

In operation 1120, the reception terminal analyzes the acquired signaling information, and recognizes a component with respect to at least one of the reference image and the 3D auxiliary image from the analyzed result.

In operation 1130, the reception terminal downloads file content with respect to at least one of the reference image and the 3D auxiliary image based on the recognized component.

Here, when the reception terminal corresponds to a 2D broadcast reception terminal, the reception terminal may recognize only a component with respect to the reference image from the analyzed result in operation 1120, and download only file contents of the reference image using the component with respect to the reference image in operation 1130.

In operation 1100, the reception terminal may download at least one of a 3D auxiliary image and signaling information corresponding to the 3D auxiliary image through a single distribution network. After completing the download, the reception terminal may download in real-time a stream of a reference image associated with the 3D auxiliary image through another distribution network.

Thereafter, the reception terminal may store the completely downloaded 3D auxiliary image and signaling information, and synchronize and display the 3D auxiliary image with the reference image downloaded in real-time based on the signaling information.

The reception terminal may select a section to be synchronized with an AV stream downloaded in real-time among sections of 3D auxiliary data based on the signaling information, and synchronize and display 3D auxiliary data of the selected section with the AV stream downloaded in real-time.

The exemplary embodiments according to the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the well-known variety and available to those having skill in the computer software arts.

It will be apparent to those skilled in the art that various modifications and variation can be made in the present invention without departing from the spirit or scope of the invention.

Thus, it is intended that the present invention cover the modifications and variations of this invention provided they come within the scope of the appended claims and their equivalents.

1. A method of transmitting a non-real time service via a broadcasting network, the method comprising:
encoding a non-real time service, wherein the non-real time service includes one or more non-real time contents and the non-real time content includes one or more files;
encoding a signaling data for the non-real time service or the non-real time content;
generating a broadcast signal including the non-real time service and the signaling data; and
transmitting the broadcast signal via the broadcast network, wherein the non-real time content is delivered in advance of its use and stored in a receiving device,
wherein the signaling data includes a service map table describing attributes of the non-real time service and a non-real time information table describing attributes of the non-real time content,
wherein the service map table includes service identification information specifying the non-real time service, and the identification information is also used as linkage between the service map table and the non-real time information table,
wherein the non-real time information table includes content linkage information linking the non-real time information table to a file delivery over unidirectional transport (FLUTE) file description table describing the one or more files included in the non-real time content, and
wherein the FLUTE file description table includes location information specifying locations of the files in the broadcast signal.

2. The method of claim 1,
wherein the non-real time service corresponds to a 3D broadcast service.

3. The method of claim 2,
wherein the non-real time contents include a first non-real time content including a reference image and a second non-real time content including a 3D auxiliary image for configuring the 3D content.

4. The method of claim 3,
wherein the non-real time information table includes type information specifying whether a non-real time content corresponds to the first non-real time content or the second non-real time content.

5. The method of claim 4,
wherein the non-real time information table further includes linkage information linking the second non-real time content to the first non-real time content.

6. A method of receiving a non-real time service via a broadcasting network, the method comprising:
receiving a broadcast signal including a non-real time service and signaling data via the broadcast network, wherein the non-real time service includes one or more non-real time contents, the non-real time content includes one or more files, and the non-real time content is delivered in advance of its use and stored in a receiving device;
parsing the signaling data for the non-real time service or the non-real time content; and
decoding the non-real time service based on the parse signaling data,
wherein the signaling data includes a service map table describing attributes of the non-real time service and a non-real time information table describing attributes of the non-real time content,
wherein the service map table includes service identification information specifying the non-real time service, and the identification information is also used as linkage between the service map table and the non-real time information table,
wherein the non-real time information table includes content linkage information linking the non-real time information table to a file delivery over unidirectional transport (FLUTE) file description table describing the one or more files included in the non-real time content, and
wherein the FLUTE file description table includes location information specifying locations of the files in the broadcast signal.

7. The method of claim 6,
wherein the non-real time service corresponds to a 3D broadcast service.

8. The method of claim 7,
wherein the non-real time contents include a first non-real time content including a reference image and a second non-real time content including a 3D auxiliary image for configuring the 3D content.

9. The method of claim 8
wherein the non-real time information table includes type information specifying whether a non-real time content corresponds to the first non-real time content or the second non-real time content.

10. The method of claim 9,
wherein the non-real time information table further includes linkage information linking the second non-real time content to the first non-real time content.
